(19) United States
(12) Patent Application Publication
(10) Pub. No.: US 2026/0346490 A1
(43) Pub. Date: Nov. 5, 2026

(54) METHOD FOR OPERATING A SLICING MACHINE AND SLICING MACHINE

(71) Applicant: MULTIVAC SEPP HAGGENMÜLLER SE & CO. KG, Wolfertschwenden (DE)

(72) Inventors: Florian RIESNER, Wolfertschwenden (DE); Christian DERSCH, Wolfertschwenden (DE); Nikolai WEBER, Wolfertschwenden (DE); Hans Christian WEISS, Wolfertschwenden (DE); Daniel SCHNEIDER, Wolfertschwenden (DE)

(73) Assignee: MULTIVAC SEPP HAGGENMÜLLER SE & CO. KG, Wolfertschwenden (DE)

(21) Appl. No.: 19/665,553

(22) Filed: May 1, 2026

(30) Foreign Application Priority Data
May 2, 2025 (DE) 102025116893.8

(51) Int. Cl. B26D 7/06; B26D 5/00

(52) U.S. Cl. CPC B26D 7/06; B26D 5/005; B26D 2210/02

(57) ABSTRACT

A method for operating a slicing machine configured to slice at least one product from a foodstuff comprises: loading a feeding unit of the slicing machine with the at least one product, wherein the loading comprises: feeding, by the feeding unit, the at least one product along a feeding direction towards a cutting unit of the slicing machine, based on a feeding command which is input, preferably manually, at a user interface of the slicing machine, wherein the loading further comprises: during feeding, monitoring an actual loading feed speed of a movement of the feeding unit along the feeding direction, by a control unit of the slicing machine, and interrupting the feeding and stopping the movement of the feeding unit if the actual loading feed speed is greater than a predetermined maximum permissible loading feed speed of the feeding unit. The disclosure further relates to a slicing machine.

### CROSS-REFERENCE TO RELATED APPLICATIONS

This application claims foreign priority benefits under 35 U.S.C. § 119(a)-(d) to German patent application number DE 102025116893.8, filed May 2, 2025, which is incorporated by reference in its entirety.

### SUMMARY

The disclosure relates to a method for operating a slicing machine configured to slice at least one product from a foodstuff, comprising the step of:
loading a feeding unit of the slicing machine with the at least one product,
wherein the step of loading comprises:
   feeding, by means of the feeding unit, the at least one product along a feeding direction towards a cutting unit of the slicing machine, on the basis of a feeding command which is input, preferably manually, at a user interface of the slicing machine. The disclosure further relates to a slicing machine.

It should be noted already at this point that the method according to the disclosure and the slicing machine operated by means of the method according to the disclosure, respectively, may be intended for slicing products, in particular product calibres, in the form of foodstuffs such as meat, sausage, cheese or the like. The cutting unit may comprise a knife which may be movable in a cutting plane. For example, the knife may be driven to rotate about an axis of rotation. By means of the knife, the slices may be separated from an end of the at least one product calibre facing the cutting unit.

Conventional slicing machines may often be loaded automatically with products using loading units, in particular in the form of feeding conveyors, for example via the rear of the slicing machine. However, situations regularly arise in which manual loading of the slicing machine with at least one product is necessary or desirable.

During a manual loading process, however, significant time delays often occur for safety reasons, as the slicing machine, in particular the cutting unit, frequently has to be switched off for a manual loading process in order to comply with safety regulations. Furthermore, when loading, i.e. after placing the at least one product on the feeding unit, the feeding unit must frequently be moved manually in and/or against the feeding direction in order to position the at least one product for the slicing operation or, where necessary, to enable it to be gripped by a gripper unit. However, if a protective housing, in particular a loading flap, of the slicing machine is open, the feeding unit must usually be in a switched-off state or at least a state blocked by a braking device, which often makes manual loading extremely cumbersome, as the entire protective housing, i.e. also the loading flap, must frequently be closed in order to move the feeding unit.

It is therefore an object of the disclosure to remedy this situation, in particular by providing a method for operating a slicing machine and a slicing machine which enable simplified, yet safe and time-efficient, preferably manual, loading of a slicing machine.

According to the disclosure, this object is solved by a method of the type mentioned above, in which the step of loading further comprises:
during feeding, monitoring an actual loading feed speed of a movement of the feeding unit along the feeding direction, by means of a control unit of the slicing machine, and
interrupting the feeding and stopping the movement of the feeding unit if the actual loading feed speed is greater than a predetermined maximum permissible loading feed speed of the feeding unit.

Due to the fact that, according to the disclosure, the actual loading feed speed of the movement of the feeding unit along the feeding direction is monitored during feeding, and the feeding is interrupted and the movement of the feeding unit is stopped if the actual loading feed speed is greater than a predetermined maximum permissible loading feed speed, the safety of a user of the slicing machine can be ensured during the entire loading process, so that even during loading, in particular whilst at least one loading flap of a protective housing of the slicing machine is open, movement of the feeding unit in and preferably against the feeding direction may be permitted. This allows the loading process to be shortened in terms of time and the overall user-friendliness of the slicing machine to be increased.

The feeding command may be input manually by a user of the slicing machine, for example by pressing a button and/or operating a control panel and/or a touch screen at the user interface.

For monitoring the actual loading feed speed, as well as preferably all other speeds of the feeding unit to be monitored, at least one sensor unit, in particular one or more speed sensors, may be arranged on the feeding unit. The sensor unit or each sensor unit may have a signal output which may be connected to a corresponding signal input of the control unit.

The movement of the feeding unit, which is monitored in the step of monitoring and, if necessary, is interrupted and stopped, may also comprise a movement of the feeding unit against the feeding direction. The product may, for example, be a product calibre or bar, which preferably has an approximately uniform cross-section in its longitudinal direction. Furthermore, the product or product calibre may, for example, be formed from sausage, such as salami, cheese, whole muscle meat or pressed meat.

In order to ensure the safety of the loading of the slicing machine, which is preferably performed manually by the user, the predetermined maximum permissible loading feed speed is preferably lower than a predetermined maximum permissible operating feed speed of the feeding unit for a slicing operation of the slicing machine and/or for an automatic loading operation of the slicing machine. In this context, the operational feed speed may be a speed at which the feeding unit can move during automated loading, for example via the rear of the slicing machine, and/or during a slicing operation of the slicing machine. In this context, the predetermined maximum permissible operating feed speed may be at least twice, preferably at least three times, and more preferably at least four times, the predetermined maximum permissible loading feed speed.

If the at least one product is also to be held by a gripper unit during slicing, it is proposed that the step of loading further comprises:
approaching a gripper unit of the feeding unit to the at least one product along the feeding direction, wherein the gripper unit is brought into engagement with the at least one product,
during approaching, monitoring an actual approach speed of a movement of the gripper unit along the feeding direction by means of the control unit, and
interrupting the approaching and stopping the movement of the gripper unit if the actual approach speed is greater than a predetermined maximum permissible approach speed. The predetermined maximum permissible approach speed may, in magnitude, substantially correspond to or differ from the predetermined maximum permissible loading feed speed.

According to a further embodiment, it is proposed that feeding along the feeding direction is performed only for as long as the feeding command is present at the user interface and is interrupted as soon as the feeding command is no longer present at the user interface. The feeding command may be input by a user of the slicing machine via the actuation, in particular of a button and/or a control panel and/or a touch screen, at the user interface. Preferably, the feeding command is present only for as long as the user interface is actively operated by the user. The mode of operation may correspond to the principle of a so-called ‘dead man’s switch’.

According to a particularly preferred embodiment, it may be provided that, as soon as the feeding command is no longer present at the user interface, a standstill condition of the feeding unit is monitored by the control unit, wherein the standstill condition is only fulfilled if the feeding unit moves at most at an actual safety speed in the direction of or against the feeding direction, which is equal to or less than a predetermined maximum permissible safety speed, wherein the predetermined maximum permissible safety speed is less than the predetermined maximum permissible loading feed speed. In this context, the standstill condition is preferably met if the feeding unit moves only at the lowest speed or not at all in or against the feeding direction. Preferably, as long as the standstill condition is met, no braking unit, such as a motor holding brake, acts on the feeding unit. This allows the feeding unit to be moved again at the predetermined maximum permissible safety speed after a very short time, as soon as the feeding command is present again.

According to a preferred further development of the latter embodiment, the predetermined maximum permissible safety speed in the direction of or against the feeding direction may be at most approximately 10 mm/s, preferably at most approximately 5 mm/s, more preferably at most approximately 1 mm/s, and most preferably at most approximately 0.5 mm/s. This is possible, for example, when the feeding unit is in a so-called position control during the standstill condition, in which a position of the feeding unit and the movable components thereof, respectively, can be changed minimally, but preferably barely visibly, by control interventions of the control unit.

To enable manual loading that is sufficiently fast yet still safe, it is proposed that the predetermined maximum permissible loading feed speed and/or the predetermined maximum permissible approach speed along the feeding direction be at most approximately 400 mm/s, preferably at most approximately 200 mm/s, more preferably approximately 100 mm/s, and most preferably approximately 50 mm/s.

For reasons of operational safety, it is further proposed that the slicing machine be switched to an emergency stop operating state if
the actual loading feed speed is greater than the predetermined maximum permissible loading feed speed, and/or
the actual approach speed is greater than the predetermined maximum permissible approach speed, and/or
the actual safety speed is greater than the predetermined maximum permissible safety speed.

In the emergency stop operating state, preferably a braking unit, in particular a motor holding brake, of the feeding unit may be actuated, which prevents further movement of the feeding unit in and/or against the feeding direction. Furthermore, in the emergency stop operating state, the cutting unit may be deactivated, i.e. for example, a cutting blade of the cutting unit rotating about an axis of rotation may be stopped.

In order to perform the, preferably manual, loading as time-efficiently as possible whilst the slicing machine is in operation, the step of loading may be performed whilst the cutting unit of the slicing machine is in operation, during which preferably the cutting blade of the cutting unit moves, preferably rotating about an axis of rotation. It is therefore not strictly necessary to switch off the cutting unit before loading.

It is further proposed that loading, preferably by a user of the slicing machine, takes place via a loading opening, preferably lateral relative to the feeding direction, which is arranged on a protective housing of the slicing machine. Preferably, the loading opening may be closed by a loading flap, in particular one that can be pivoted about a pivot axis. Furthermore, the loading flap is preferably integrated into a protective door of the protective housing, so that for loading the slicing machine with the at least one product, only the loading flap, but not the entire protective door, needs to be opened.

Furthermore, the method may, in a manner known per se, further comprise the following step(s):
slicing the at least one product into slices by means of the cutting unit, and
preferably forming portions by means of a portioning unit of the slicing machine, wherein each portion comprises one or more slices. The portioning unit may preferably be a portioning belt or the like and may be arranged downstream of the cutting unit relative to the feeding direction.

In order to minimise or, ideally, completely eliminate any risk of injury to a user of the slicing machine during loading, a protective unit, in particular a protective slide, may operate in the region of the cutting unit during the step of loading, which blocks access from the feeding unit to the cutting unit. The protective unit, in particular the protective slide, may be adjustable between an extended position, in which access from the feeding unit to the cutting unit is blocked, and a retracted position, in which access from the feeding unit to the cutting unit is unblocked.

In order to allow the control unit and the software programmes or the like running on it, respectively, sufficient time to switch between an operating state of the slicing machine in which the predetermined maximum permissible loading feed speed represents the permissible maximum speed of the feeding unit to be monitored, and another operating state of the slicing machine, in which the predetermined maximum permissible safety speed represents the permissible maximum speed of the feeding unit to be monitored, it is further proposed that, as soon as the feeding command is present at the user interface, the feeding unit only starts moving after a predetermined delay time has elapsed, and/or as soon as the feeding command is no longer present at the user interface, the feeding unit is stopped only after a predetermined further delay time has elapsed. The predetermined delay time may preferably be less than one second, for example in the range of milliseconds or tenths of a second, or in the range of a low number of seconds. This can, in particular, also prevent the slicing machine from accidentally inputting the emergency stop operating state, even though there is no cause for this.

According to a further aspect of the disclosure, the above object is solved by a slicing machine configured to slice at least one product from a foodstuff, comprising: a feeding unit configured to be loaded with the at least one product and configured to feed the at least one product along a feeding direction towards a cutting unit of the slicing machine, the cutting unit configured to slice the product in slices, a control unit configured to control the feeding unit and preferably the cutting unit, and a user interface operatively connected to the control unit, wherein the control unit is configured to control at least the feeding unit on the basis of a feeding command which is input, preferably manually, at the user interface, wherein the slicing machine is configured and intended to perform the method according to the disclosure described above.

With regard to the effects and advantages of the slicing machine according to the disclosure, reference is made to the advantages and effects of the method according to the disclosure. All features, effects and advantages described in relation to the method according to the disclosure also apply to the slicing machine according to the disclosure, and vice versa.

It should also be noted that the slicing machine may further comprise a portioning device configured to form portions from the slices sliced by the cutting unit and to convey the portions along a discharge direction. Furthermore, each portion may comprise one or more slices.

### BRIEF DESCRIPTION OF THE DRAWINGS

Embodiments according to the disclosure will be explained in more detail below with reference to the accompanying drawings:

FIG. 1A is a perspective view of an embodiment of a slicing machine according to the disclosure;

FIG. 1B is a perspective view according to FIG. 1A, in which, however, a loading flap has been moved from the position depicted in FIG. 1A into an open position;

FIG. 2 is a perspective view of the slicing machine according to FIGS. 1A and 1B, respectively, in which a side protective door has been removed for a better view;

FIG. 3 is a side view of the slicing machine according to FIG. 2; and

FIG. 4 is a schematic diagram showing exemplary actual speed profiles and corresponding maximum permissible speeds for the feeding unit.

### DETAILED DESCRIPTION

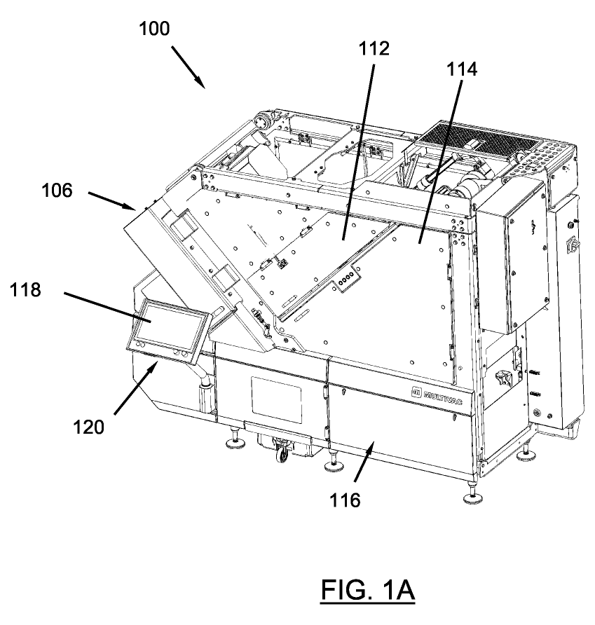

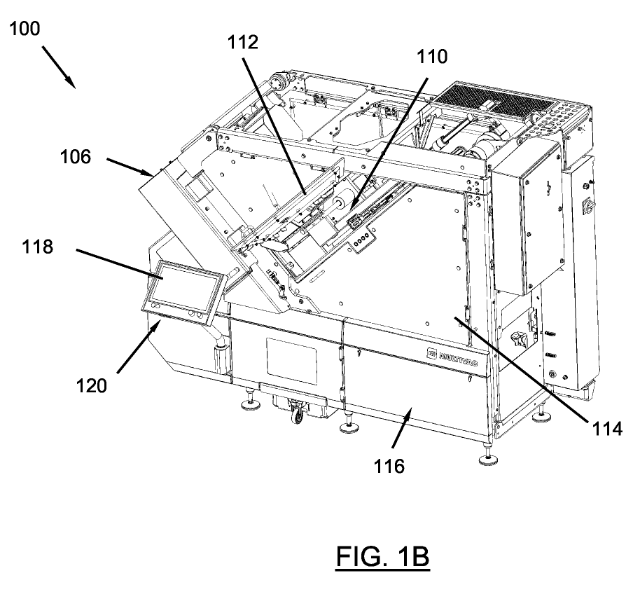

In FIGS. 1A - 3, a slicing machine according to the disclosure according to an embodiment is generally designated by reference number 100.

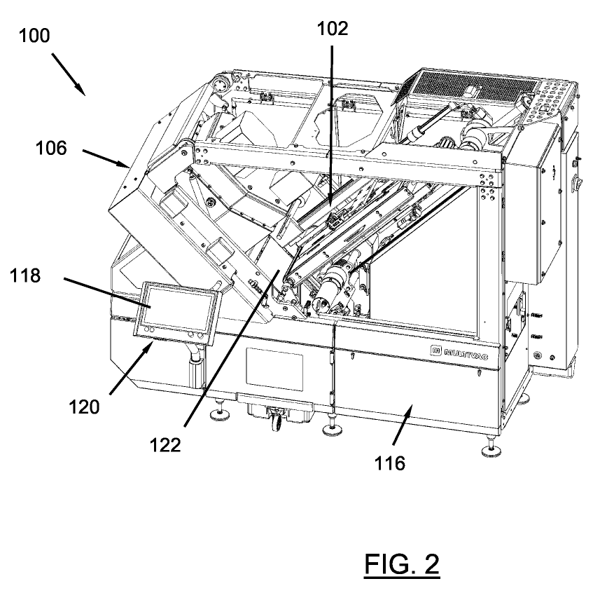

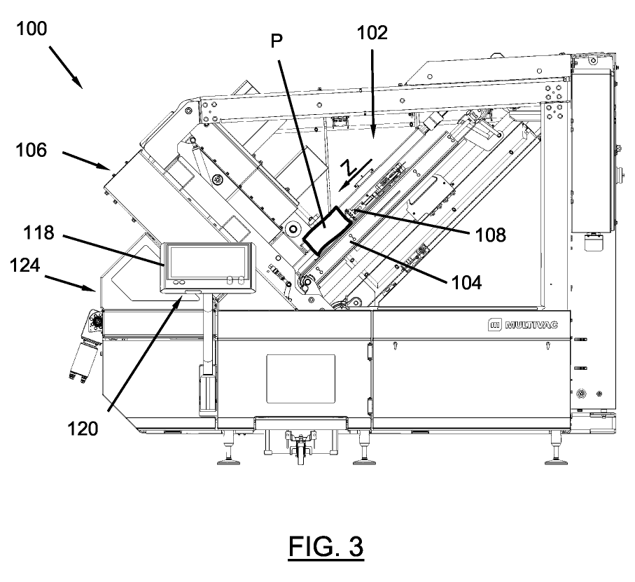

As best seen in FIGS. 2 and 3, the slicing machine 100 comprises a feeding unit 102 configured to be loaded with at least one product P from a foodstuff, for example a product calibre, in particular sausage, meat, cheese or the like. The product P is indicated only schematically in FIG. 3. The feeding unit 102 may comprise a feeding conveyor 104, for example in the form of an endless belt conveyor, on which the product P can rest during feeding to a cutting unit 106 of the slicing machine 100. Furthermore, the feeding unit 102 may comprise a gripper unit 108, which may be configured to grip and hold the product P at an end thereof facing away from the cutting unit 106. For example, the gripper unit 108 may include one or mor gripper claws. The feeding conveyor 106 and, if present, the gripping unit 108 may be movable either in or against a feeding direction Z in order to move the product P towards the cutting unit 106 or away from it.

If the slicing machine 100 is to be loaded manually, i.e. for example by hand by a user of the slicing machine 100, this may be done via a lateral loading opening 110, which can be accessed by opening a loading flap 112 (see in particular FIGS. 1A and 1B). The loading flap 112 may be integrated into a protective door 114, which may be part of a protective housing 116 of the slicing machine 100. The protective door 114, including the loading flap 112, is not illustrated in FIGS. 2 and 3 for the sake of clarity.

A distinctive feature of the slicing machine 100 according to the disclosure is that, during loading of the feeding unit 102, in particular manual loading, through the loading opening 110, preferably with the loading flap 112 open, the feeding unit 102, i.e. in this case, in particular the conveyor 104 and/or the gripper unit 108, can be moved in and against the feeding direction Z. In this context, according to the disclosure, the movement of the feeding unit 102 is effected by the input of a feeding command which, preferably manually by an operator, may be input at a user interface 118, for example a touchscreen or the like, via a button, a control panel, a control lever or the like. In this context, the user interface 118 may be part of a control unit 120 of the slicing machine 100. However, the control unit 120 may also be arranged at another position on or near the slicing machine 100 and need only be in operational signal communication with the user interface 118.

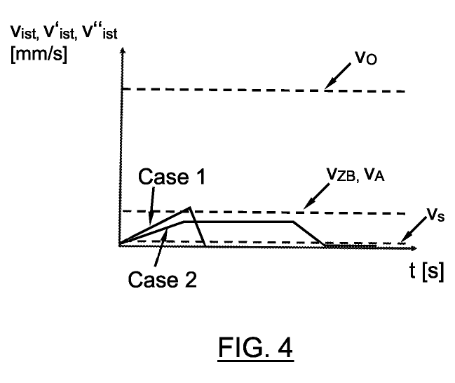

According to the disclosure, by means of the control unit 120, an actual loading feed speed Vᵢₛₜof a movement of the feeding unit 102 along the feeding direction Z is monitored during loading of the slicing machine 100 with the product P. This ensures that the feeding unit 102, i.e. in this case the gripper unit 108 and the feeding conveyor 104, moves at no more than a predetermined maximum permissible loading feed speed V_{ZB} (see also FIG. 4), at which it is ensured that a user of the slicing machine 100, who handles the product P within the protective housing 116 in the region of the feeding unit 102, cannot be injured by the movement of the feeding unit 102. In the case that the actual loading feed speed Vᵢₛₜof the feeding unit 102 should be greater than the predetermined maximum permissible loading feed speed of the feeding unit 102, the movement of the feeding unit 102 is, according to the disclosure, interrupted and stopped, and preferably the slicing machine 100 is switched to an emergency stop operating state. This applies, for example, to the speed profile according to Case 1 in the diagram according to FIG. 4, in which the actual loading feed speed Vᵢₛₜ rises to a speed that exceeds the predetermined maximum permissible loading feed speed V_{ZB} and the feeding unit 102 is therefore abruptly stopped.

As further schematically illustrated in the diagram shown in FIG. 4, the predetermined maximum permissible loading feed speed V_{ZB} may be lower than a predetermined maximum permissible operating feed speed V_{O} which applies to a slicing operation of the slicing machine 100 and/or to an automatic loading operation of the slicing machine 100.

If desired, an actual approach speed V‘ᵢₛₜ of an approach movement of the gripper unit 108 along the feeding direction Z towards the product P may also be monitored in a similar manner for the gripper unit 108. If the actual approach speed V‘ᵢₛₜ exceeds a predetermined maximum permissible approach speed V_{A}, approaching of the gripper unit 108 may be interrupted in a similar manner and the gripper unit 108 stopped on command from the control unit 120.

Similar to the principle of a dead man’s switch, the feeding unit 102 may preferably only move along the feeding direction Z for as long as the feeding command is actively present at the user interface 118, i.e. only for as long as the user of the slicing machine 100 actively operates the user interface 118, and feeding by the feeding unit 102 may be interrupted as soon as the feeding command is no longer present at the user interface 118.

In order to ensure operational safety even when the feeding unit 102 is at a standstill, i.e. in this case, the feeding conveyor 104 and the gripper unit 108, a standstill condition of the feeding unit 102 may preferably also be monitored by the control unit 120. In this context, the standstill condition may be met if the feeding unit 102 moves at most at a very low speed, or not at all, in the direction of or against the feeding direction Z, wherein such a speed may be defined by a predetermined maximum permissible safety speed V_{S}, which is lower than the predetermined maximum permissible loading feed speed V_{ZB} and may preferably be approximately 1 mm/s, or more preferably approximately 0.5 mm/s. This applies, for example, to Case 2 in the diagram according to FIG. 4, in which, upon the feeding command being present, the actual loading feed speed Vᵢₛₜrises to a speed which is below the predetermined maximum permissible loading feed speed V_{ZB}, and then, during monitoring the standstill condition, drops to an actual safety speed V‘‘ᵢₛₜ below the predetermined maximum permissible safety speed V_{S}, at which the feeding unit 102 is virtually at a standstill. The speed profile in Case 2 thus represents, in the positive direction of the time axis (t-direction), initially the profile of the actual loading feed speed Vᵢₛₜ and, during monitoring the standstill condition, the profile of the actual safety speed V‘‘ᵢₛₜ.

Loading of the slicing machine 100 may preferably be performed whilst the cutting unit 106 of the slicing machine 100 is in operation, during which a cutting blade (not visible in the figures due to the protective housing 116) of the cutting unit 106 preferably moves about an axis of rotation. To prevent the user from accidentally reaching into the region of the cutting unit 106, the slicing machine 100 may comprise a protective unit 122, which in the illustrated embodiment (see in particular FIG. 2) is designed as a protective slide. In this context, the protective unit 122 may be adjusted between an extended position illustrated in FIG. 2, in which it blocks access from the feeding unit 102 to the cutting unit 106, and a retracted position, in which it allows access from the feeding unit 102 to the cutting unit 106.

It should also be noted that as soon as the feeding command is present at the user interface 118, the feeding unit 102 can only start moving after a predetermined delay time has elapsed. Additionally or alternatively, as soon as the feeding command is no longer present at the user interface, the feeding unit 102 can only be stopped after a predetermined further delay time has elapsed. This has the advantage of allowing the control unit 120 and software programmes executed by it or the like, respectively, sufficient time to switch between an operating state of the slicing machine 100 in which the predetermined maximum permissible loading feed speed V_{ZB} applies, and another operating state of the slicing machine 100 in which the predetermined maximum permissible safety speed V_{S} applies.

It should also be noted that, in a slicing operation, the slicing machine 100 may be designed in a manner known per se to slice the product P into one or more slices, which may, for example, be shingled or stacked so as to be combined into portions, each comprising one or more slices. In this context, the portioning may be performed by a portioning unit (e.g., one or more conveyor belts), which is indicated in FIG. 3 by the reference number 124 and may be arranged downstream of the cutting unit 106 relative to the feeding direction Z.

As one skilled in the art would understand, the user interface 118, the control unit 120, as well an any other unit, system, subsystem, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

What is claimed is:

1. A method for operating a slicing machine configured to slice at least one product from a foodstuff, comprising:
loading a feeding unit of the slicing machine with the at least one product;
wherein the loading comprises:
feeding, by the feeding unit, the at least one product along a feeding direction towards a cutting unit of the slicing machine, based on a feeding command which is input at a user interface of the slicing machine;
during the feeding, monitoring an actual loading feed speed of a movement of the feeding unit along the feeding direction, by a control unit of the slicing machine; and
interrupting the feeding and stopping the movement of the feeding unit when the actual loading feed speed is greater than a predetermined maximum permissible loading feed speed of the feeding unit.

2. The method according to claim 1, wherein the predetermined maximum permissible loading feed speed is lower than a predetermined maximum permissible operating feed speed of the feeding unit for a slicing operation of the slicing machine and/or for an automatic loading operation of the slicing machine.

3. The method according to claim 1, wherein the loading further comprises:
approaching a gripper unit of the feeding unit to the at least one product along the feeding direction, wherein the gripper unit is brought into engagement with the at least one product;
during the approaching, monitoring an actual approach speed of a movement of the gripper unit along the feeding direction by the control unit; and
interrupting the approaching and stopping the movement of the gripper unit when the actual approach speed is greater than a predetermined maximum permissible approach speed.

4. The method according to claim 3, wherein the predetermined maximum permissible loading feed speed and/or the predetermined maximum permissible approach speed along the feeding direction are/is at most about 400 mm/s.

5. The method according to claim 3, wherein the predetermined maximum permissible loading feed speed and/or the predetermined maximum permissible approach speed along the feeding direction are/is at most about 200 mm/s.

6. The method according to claim 3, wherein the predetermined maximum permissible loading feed speed and/or the predetermined maximum permissible approach speed along the feeding direction are/is at most about 100 mm/s.

7. The method according to claim 3, wherein as soon as the feeding command is no longer present at the user interface, a standstill condition of the feeding unit is monitored by the control unit, wherein the standstill condition is only fulfilled if the feeding unit moves at most at an actual safety speed in a direction of or against the feeding direction, which is equal to or less than a predetermined maximum permissible safety speed, wherein the predetermined maximum permissible safety speed is less than the predetermined maximum permissible loading feed speed.

8. The method according to claim 7, wherein the slicing machine is switched to an emergency stop operating state when
the actual loading feed speed is greater than the predetermined maximum permissible loading feed speed, and/or
the actual approach speed is greater than the predetermined maximum permissible approach speed, and/or
the actual safety speed is greater than the predetermined maximum permissible safety speed.

9. The method according to claim 1, wherein the feeding along the feeding direction is performed only for as long as the feeding command is present at the user interface and is interrupted as soon as the feeding command is no longer present at the user interface.

10. The method according to claim 1, wherein as soon as the feeding command is no longer present at the user interface, a standstill condition of the feeding unit is monitored by the control unit, wherein the standstill condition is only fulfilled if the feeding unit moves at most at an actual safety speed in a direction of or against the feeding direction, which is equal to or less than a predetermined maximum permissible safety speed, wherein the predetermined maximum permissible safety speed is less than the predetermined maximum permissible loading feed speed.

11. The method according to claim 10, wherein the predetermined maximum permissible safety speed in the direction of or against the feeding direction is at most approximately 10 mm/s.

12. The method according to claim 10, wherein the predetermined maximum permissible safety speed in the direction of or against the feeding direction is at most approximately 5 mm/s.

13. The method according to claim 1, wherein the predetermined maximum permissible loading feed speed along the feeding direction is at most about 400 mm/s.

14. The method according to claim 1, wherein the loading is performed whilst the cutting unit of the slicing machine is in operation, during which a cutting blade of the cutting unit moves.

15. The method according to claim 1, wherein the loading takes place via a loading opening oriented laterally relative to the feeding direction.

16. The method according to claim 15, wherein a protective housing of the slicing machine defines the loading opening.

17. The method according to claim 1, further comprising:
slicing the at least one product into slices by the cutting unit, and
forming portions by a portioning unit of the slicing machine, wherein each portion comprises one or more slices.

18. The method according to claim 1, wherein, during the loading, a protective unit operates in a region of the cutting unit, which blocks access from the feeding unit to the cutting unit.

19. The method according to claim 1, wherein,
as soon as the feeding command is present at the user interface, the feeding unit only starts moving after a predetermined delay time has elapsed, and/or
as soon as the feeding command is no longer present at the user interface, the feeding unit is stopped only after a predetermined further delay time has elapsed.

20. A slicing machine configured to slice at least one product from a foodstuff, comprising:
a cutting unit configured to slice the at least one product into slices;
a feeding unit configured to be loaded with the at least one product and configured to feed the at least one product along a feeding direction towards the cutting unit;
a control unit configured to control the feeding unit; and
a user interface operatively connected to the control unit, wherein the control unit is configured to control the feeding unit based on a feeding command which is inputtable at the user interface;
wherein during feeding of the at least one product toward the cutting unit by the feeding unit, the control unit is configured to monitor an actual loading feed speed of a movement of the feeding unit along the feeding direction, and interrupt the feeding and stop the movement of the feeding unit when the actual loading feed speed is greater than a predetermined maximum permissible loading feed speed of the feeding unit.
